(19) United States
(12) Patent Application Publication
(10) Pub. No.: US 2025/0116869 A1
(43) Pub. Date: Apr. 10, 2025

(54) MODULAR FORM FACTOR FOR WEARABLE AUGMENTED REALITY DISPLAYS

(71) Applicant: GOOGLE LLC, Mountain View, CA (US)

(72) Inventors: Lloyd Frederick Holland, Kitchener (CA); Geoffrey Gudgeon, Waterdown (CA); Joshua Moore, Elora (CA)

(21) Appl. No.: 18/483,586

(22) Filed: Oct. 10, 2023

(51) Int. Cl. G02B 27/01; G02C 11/00; G09G 3/00

(52) U.S. Cl. CPC G02B 27/0176; G02C 11/10; G09G 3/002; G02B 2027/0178

(57) ABSTRACT

A display system comprises a first frame structure housing one or more processors and wearable proximate to a user's eye, and a second frame structure coupled to a light engine and various optical elements. The light engine generates display light indicative of graphical content, with the optical elements channeling the display light to the user's eye. The processors of the first frame structure control operations of the light engine via a selectively detachable connection between an electromechanical interface of the first frame structure and a corresponding electromechanical interface of the second frame structure.

### BACKGROUND

The present disclosure relates generally to wearable electronic display technology, and more specifically to modular eyeglasses that provide a selectably detachable augmented reality (AR) display for both continuous and episodic use.

One challenge in developing wearable augmented reality (AR) display devices with improved user comfort has been developing an ergonomic and lightweight form factor. Improved aesthetics of such devices are generally associated with greater social acceptability and user adoption.

Furthermore, individuals who rely on prescription glasses encounter additional barriers in physical and vision comfort when using AR glasses. The layers of optical features associated with AR functionality often conflict with the requirements of prescription lenses, sometimes leading to reduced vision clarity. Additionally, the more features and functionalities incorporated into the wearable display device, the more the device tends to compromise on size and weight, making them less suitable for prolonged wear.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIGS. 1-4 illustrate various views of a modular AR display device 100 in accordance with some embodiments:

FIG. 1 illustrates a top-down view of a modular AR display device in accordance with some embodiments.

FIG. 2 illustrates a side profile view of a wearable frame and multiple perspective views of a removable frame of a modular AR display device configured in accordance with some embodiments.

FIGS. 3 and 4 illustrate different perspective views of a modular AR display device configured in accordance with some embodiments.

FIG. 5 is a component-level block diagram illustrating an example of a processing system suitable for implementing one or more embodiments.

### DETAILED DESCRIPTION

Despite recent improvements in augmented reality (AR) display systems, the majority of users of such systems typically do not utilize such display systems during the entirety of their waking day. For example, while AR displays might be immensely beneficial for specific tasks like navigation, professional training, or interactive gaming, users might find it unnecessary or even distracting during more routine or mundane activities such as reading a book, having face-to-face conversations, or engaging in sporting activities. Furthermore, continuously wearing a bulky AR device can be cumbersome and may not always align with the user's aesthetic preferences or comfort requirements. Thus, a distinction between ‘all-day use’ versus ‘episodic use’ encourages the development of techniques for transitioning between these use cases with minimal effort on the part of the user.

Embodiments of techniques described herein provide wearable AR display systems having a form factor of eyewear (e.g., eyeglasses and/or sunglasses) that integrate AR display functionality in a modular and selectably removable manner, allowing users to choose when they want an AR experience and when they prefer a more traditional eyewear experience. This approach addresses both the desirability of customizable user experiences as well as the technical challenges of creating ergonomic, lightweight, and aesthetically pleasing AR eyewear.

In certain embodiments, an electromechanical interface is provided to facilitate one or more selectably detachable connections between a wearable frame structure of the eyewear and a removable frame structure that includes one or more AR display systems. The electromechanical interface provides both power transfer and communications between one or more components coupled to (e.g., substantially housed within) the wearable frame structure and one or more second components coupled to (e.g., substantially housed within) the removable frame structure.

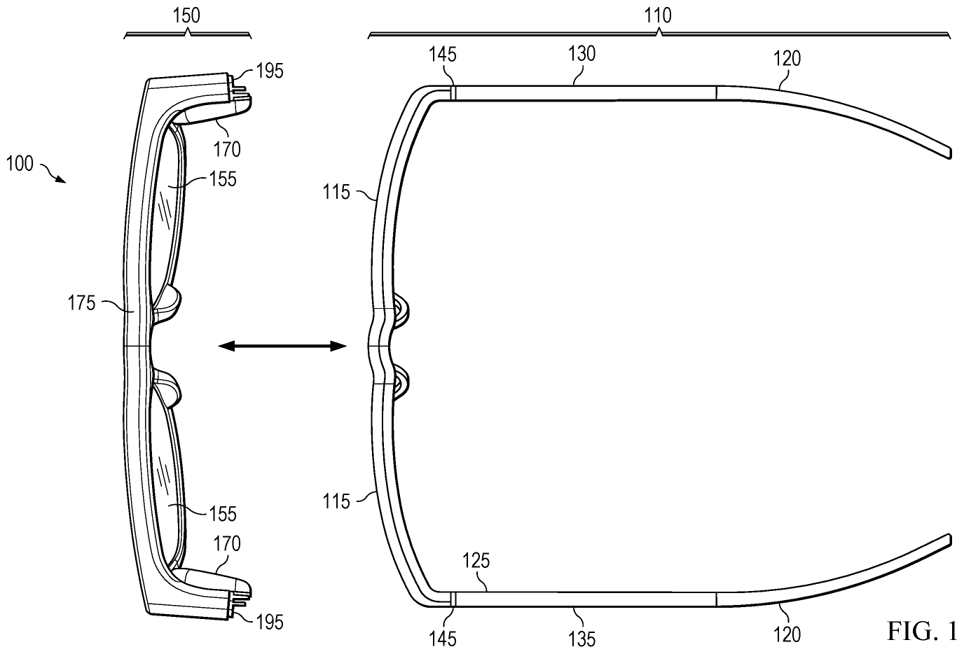

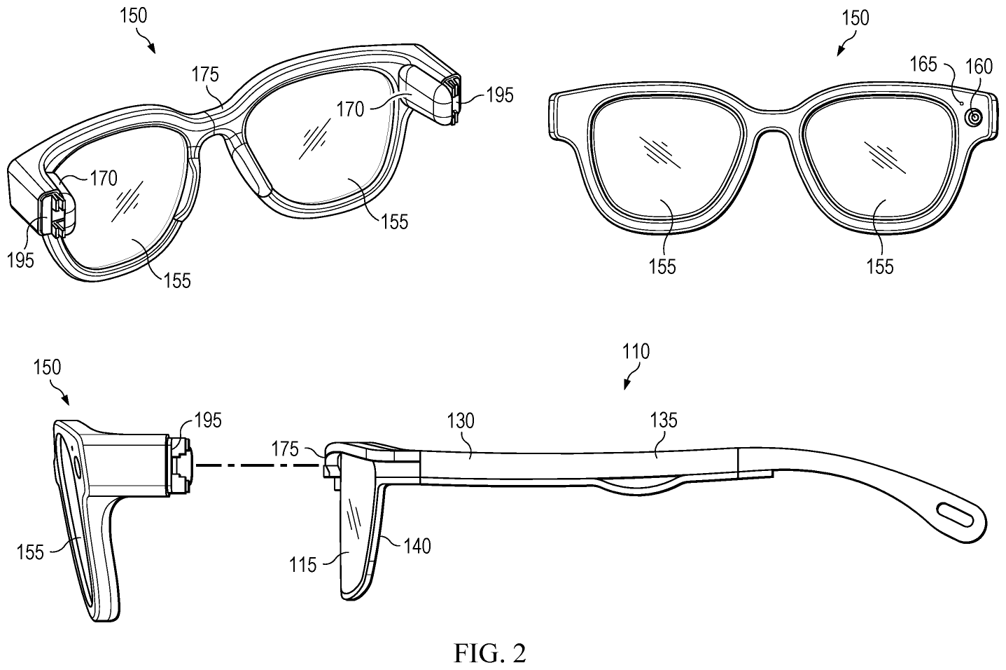

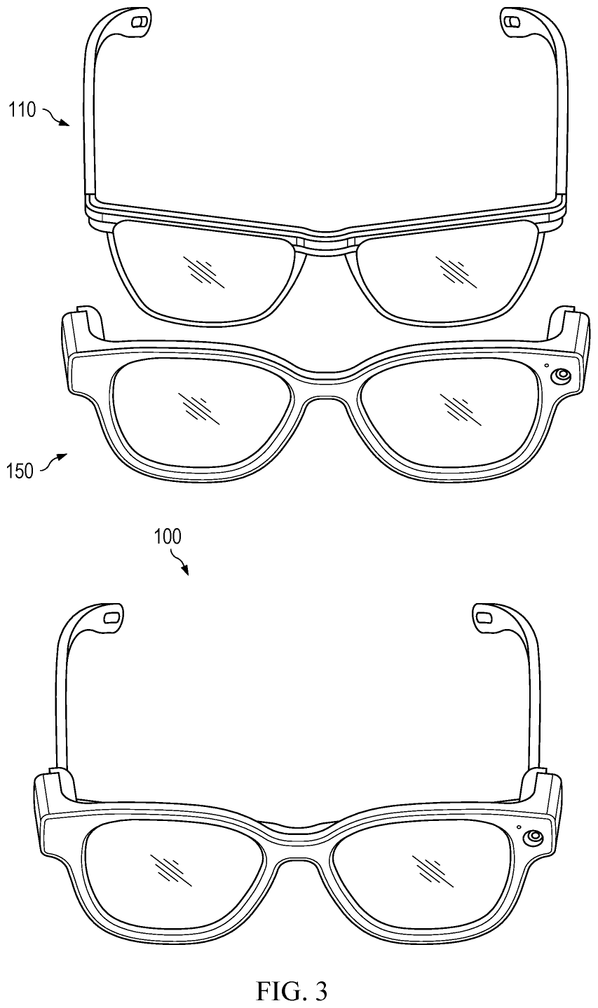

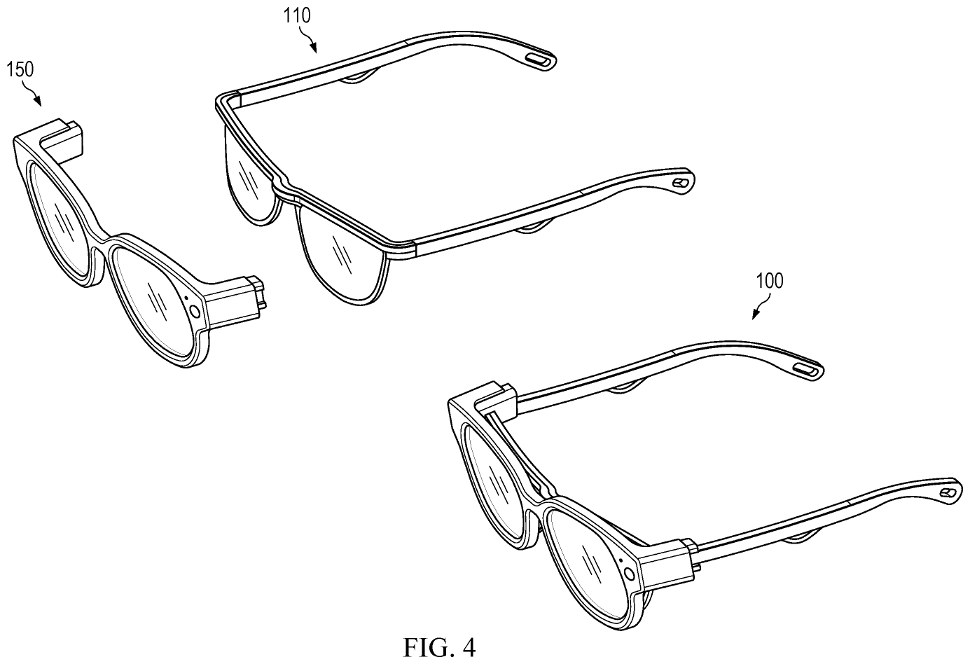

FIGS. 1-4 illustrate various views of a modular AR display device 100 in accordance with some embodiments. In particular, FIG. 1 illustrates a top-down view of the modular AR display device. FIG. 2 illustrates a side profile view of a wearable frame 110 and multiple perspective views of a removable frame 150 of the modular AR display device. FIGS. 3 and 4 illustrate perspective views of the modular AR display device 100 in different states of connection between its modular components.

In the depicted embodiment, the modular AR display device 100 encompasses a wearable frame 110 and a removable frame 150. It will be appreciated that while an example form factor is depicted for ease of illustration, in other embodiments the modular AR display device 100 may have a different shape and appearance from the eyeglasses frame illustrated as the example in FIGS. 1-4. As used herein, instances of the term “or” herein refer to the non-exclusive definition of “or”, unless noted otherwise. For example, herein the phrase “X or Y” means “either X, or Y, or both”.

The wearable frame 110, depicted on the right-hand side of FIG. 1, serves as the base structure for a user to wear in proximity to their eye(s), and includes substantially transparent lenses 115. The lenses 115 provide visual clarity and may be configured to provide corrective optical power (e.g., in accordance with a medical vision prescription), accommodating users with vision impairments while the wearable frame 110 is in use.

Also in the depicted embodiment, the wearable frame 110 includes one or more audio outputs (e.g., speakers) 120. The audio output(s) 120 are configured to provide audio output for various applications, such as for navigation, media playback, and communication. In certain embodiments, multiple audio outputs 120 are strategically positioned to offer directional audio, such as to enhance immersion during the presentation of AR content.

Additionally positioned substantially within the wearable frame 110 are one or more sensors 125. In various embodiments, such sensors 125 include one or more microphones (such as for audio capture, communication, voice recognition, etc.); cameras (such as for use in image capture, gesture recognition, ambient light detection); accelerometers, to sense motion of the wearable frame 110; touch pads, buttons, or other input controls or actuators; ambient light sensors; light detection and ranging (LIDAR) sensors; or other sensors for detecting aspects of the external environment.

The wearable frame 110 further comprises a controller 130 to manage and coordinate various device functions. The controller 130 receives and interprets input (including user input) from sensors 125, processes data (including data transmitted or received via one or more radio frequency (RF) interfaces or other wireless communication interfaces, such as a Bluetooth® interface or WiFi interface, not separately depicted), and manages output such as presentation of visual and audio content. In various embodiments, the controller 130 may include or be communicatively coupled to one or more non-transitory processor-readable storage media or memories storing processor-executable instructions and other data that, when retrieved and/or executed by the controller 130, cause the controller 130 to control the operation of the components of the wearable frame 110 and additional components of the modular AR display system 100, such as components connected as part of the removable frame 150.

For connectivity purposes, the wearable frame 110 is equipped with one or more antennas 140 (with reference to FIG. 2). The antennas 140 facilitate connections to one or more wireless networks, to one or more communications devices (e.g., a cellular-based smartphone or other mobile communications device), and enable global positioning system (GPS) functionality, as non-limiting examples.

Also in the depicted embodiment, the wearable frame 110 includes power storage 135 for supplying power to the electrical components of the modular AR display device 100. In embodiments, power storage 135 comprises one or more types of rechargeable battery storage, such as lithium-ion (Li-ion), lithium-polymer (LiPo), nickel-metal hydride (NiMH), or solid-state batteries. In certain embodiments, one or more such battery types may be selected for power storage 135 based on their relative energy density, longevity, and safety profiles. For example, Li-ion batteries are associated with relatively high energy density and long cycle life, making them suitable for prolonged AR experiences; LiPo batteries, while similar to Li-ion in many aspects, typically allow a more flexible form factor, allowing for more attractive design elements for the wearable frame 110.

A removable frame 150 carries various components for presentation of AR content to a user of the wearable frame 110 contains or otherwise includes various components to facilitate the projection of such images toward the eye of the user, such as a light engine and a waveguide. In particular, the removable frame 150 comprises monocular or binocular AR display lens stacks 155, each of which includes one or more waveguides, incouplers, outcouplers, and other optical elements, as discussed in greater detail elsewhere herein. In general, the lens stacks 155 are designed.

The AR display system 170 works in conjunction with the lens stack(s) 155 to project display light, generated by a light engine (not separately shown) and representing AR content into the user's field of view, and to combine that AR content with external light passing through the lens stacks 155 and transparent lenses 115 of the wearable frame 110. As used herein, augmented reality (AR) content may include any renderable form of audiovisual content, including textual content, graphical and/or video content rendered in two-dimensional or three-dimensional space, and the like.

In certain embodiments, the AR display system 170 includes a light engine (e.g., a laser projector, a micro-LED projector, a Liquid Crystal on Silicon (LCOS) projector, or the like, not separately depicted). The light engine is configured to project images toward the eye of a user via one or more waveguides and other optical elements (not separately depicted) of lens stacks 155, such that the user perceives the projected images as being displayed in a field of view (FOV) area of one or both of the lens stacks 155. As used herein, a lens stack comprises a lens structure of a display assembly (also referred to herein as a lens stack “structure” or lens structure) that may include multiple lens layers, and in certain embodiments may comprise one or more display optics (e.g., one or more optical redirector elements) disposed between or incorporated by such lens layers to produce a heads-up display (HUD), such as to present AR content or other display content. Thus, in the depicted embodiment, the display system 170 at least partially operates as a near-eye display system in the form of a wearable heads-up display (WHUD).

One or both of the lens stacks 155 are used by the AR display system 170 to provide an augmented reality (AR) display in which rendered graphical content can be superimposed over or otherwise provided in conjunction with a real-world view as perceived by the user through the lens stacks 155. For example, a projection system of the AR display system 170 uses light to form a perceptible image or series of images by projecting display light onto the eye of the user via a light engine of the projection system, a waveguide formed at least partially in the corresponding lens stack 155, and one or more additional optical elements (e.g., one or more scan mirrors, one or more optical relays, or one or more collimation lenses that are disposed between the light engine and the waveguide or integrated with the waveguide, not shown), according to various embodiments.

One or both of the lens stacks 155 comprises multiple layers, at least one of which layers includes at least a portion of a waveguide that routes display light received by an incoupler of the waveguide to an outcoupler of the waveguide. The waveguide outputs the display light toward an eye of a user of the AR display system 170. The display light is modulated and projected onto the eye of the user such that the user perceives the display light as an image. In addition, each of the lens stacks 155 (and transparent lenses 115 of the wearable frame 110) is sufficiently transparent to allow a user to see through the lens elements to provide a field of view of the user's real-world environment such that the displayed image appears superimposed over at least a portion of the real-world environment. In addition, in certain embodiments one or both of the lens stacks 155 includes at least one layer configured to provide some degree of focal correction, such as to supplement corrective elements of transparent lenses 115 and/or to provide focal depth placement of one or more AR elements in the user's field of view.

In some embodiments, the light engine of the AR display system 170 is a digital light processing-based light engine, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, a display panel of the light engine is configured to output light (representing an image or portion of an image for display) into the waveguide, which expands the display light and outputs the display light toward the eye of the user via an outcoupler.

In some embodiments, the AR display system 170 is communicatively coupled to one or more processors (not shown) that generate content to be displayed, such as one or more processors of a mobile communication device that is communicatively coupled to the AR display device 100.

Supplementing the power storage 135 of the wearable frame 110, in the depicted embodiment the removable frame 150 includes supplemental power storage 175, such as to enable extended use when presenting AR or other content to the user via components of the removable frame 150. In a manner similar to that described above with respect to power storage 135, supplemental power storage 175 comprises one or more types of rechargeable battery storage, such as Li-ion, LiPo, NiMH, or solid-state batteries.

An electromechanical interface 145 (of the wearable frame 110) and electromechanical interface 195 (of the removable frame 150) interoperate in order to enable the selective attachment and removal of the removable frame 150 to/from the wearable frame 110, providing both communication and power transfer. In certain embodiments, the electromechanical interfaces 145, 195 are designed for a physical, pin-like or pogo pin connection. However, it will be appreciated that in various embodiments, various types of electromechanical and magnetic interfaces are utilized as part of the electromechanical interfaces 145, 195 for connecting the wearable frame 110 to the removable frame 150. For example, in various embodiments complementary magnets are respectively positioned on the wearable frame 110 and removable frame 150, either exposed or hidden behind cosmetic surfaces of one or both such frames, for use in securing and/or aligning the wearable frame 110 and removable frame 150 with respect to one another. As another example, in certain embodiments electrical connections are made using complementary arrangements on the wearable frame 110 and removable frame 150 of one or more pogo pins and contact pads; for some embodiments in which these elements are utilized to form electrical connections between the wearable frame 110 and removable frame 150, complementary magnets are utilized as well, such that the pogo pins and contact pads are engaged when the magnetic surfaces align and attract. In other embodiments, mechanical clips, snaps, hooks, or slide locking interfaces are used to mutually secure the wearable frame 110 and removable frame 150. As additional non-limiting examples, one or more of the following elements may be utilized for that purpose: a spring-loaded terminal interface; optical data interface; zero insertion force (ZIF) connectors; etc. In any case, such interface allows users to swiftly switch between a daily use scenario while wearing wearable frame 110 to a high-resolution AR content experience.

In use, when the removable frame 150 is connected to the wearable frame 110 via electromechanical interfaces 145, 195, the controller 130 undertakes a series of operations to integrate control of the components of the modular AR display device 100, including those carried by the removable frame 150. In various embodiments and as non-limiting examples, such operations include detection and handshake, in which the controller 130 acknowledges and/or enumerates addressable components of the removable frame 150; power management, in which the controller 130 identifies the supplemental power storage 175 and adjusts power distribution and consumption accordingly, potentially drawing additional power from the supplemental power storage 175 for, e.g., displaying content via the display system 170 of the removable frame 150; AR display activation, such as to initiate processing of AR content for presentation via the display system 170 and audio outputs 120; sensor integration; activation of one or more instruction modules, such as one or more applications or device drivers; data transfer or storage, such as to adjust data transfer rates and storage locations based on a type or volume of data to be transferred based on the connection; connectivity adjustments, such as to accommodate different data transfer rates over wireless networks or to prioritize selected types of data traffic in order to improve the presentation of AR content via the newly attached removable frame 150; one or more feedback mechanisms, such as to inform (via visual, auditory, or haptic indications) the user that successful connection has been achieved between the wearable frame 110 and components of the removable frame 150; and other operations responsive to the connection between the electromechanical interfaces 145, 195.

In various embodiments, the electromechanical interfaces 145, 195 support both the bidirectional transfer of instructions and other data and also the supplementary power needs of the modular AR display device 100. In this manner, the power storage 135 of the wearable frame 110 is complemented by the supplemental power storage 175 of the removable frame 150, extending operational duration.

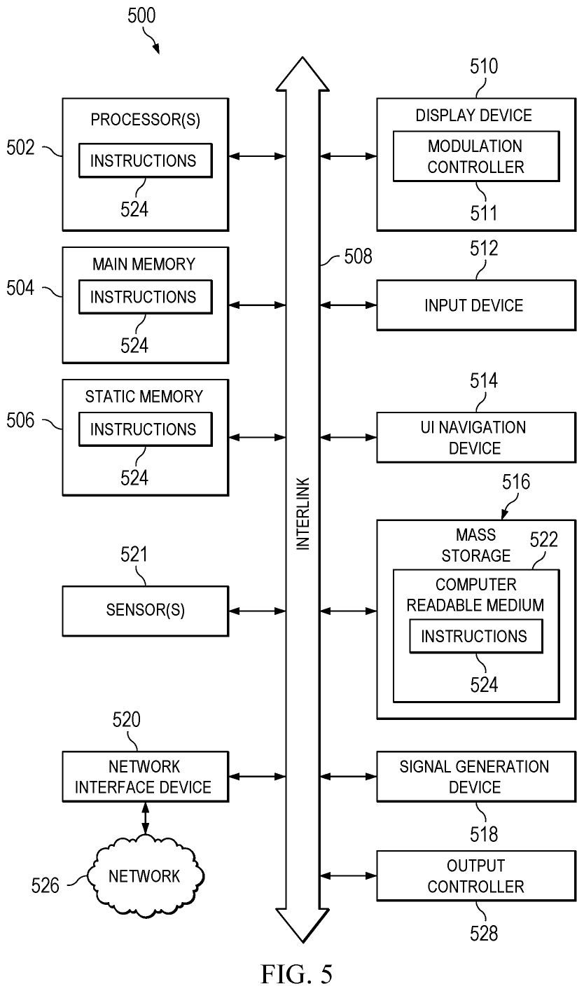

FIG. 5 is a component-level block diagram illustrating an example of a processing system 500 suitable for implementing one or more embodiments. In alternative embodiments, the processing system 500 may operate as a standalone device or may be connected (e.g., networked) to other systems. In various embodiments, one or more components of the processing system 500 may be incorporated within one or more portions (e.g., wearable frame 110 or removable frame 150) of a display device (e.g., modular AR display device 100) to provide various types of AR or other content. It will be appreciated that in various embodiments, such a display system may include some components of processing system 500, but not necessarily all of them. In a networked deployment, the processing system 500 may operate in the capacity of a server machine, a client machine, or both in server-client network environments. In an example, the processing system 500 may act as a peer system in peer-to-peer (P2P) (or other distributed) network environment. The processing system 500 may comprise any system capable of executing instructions (sequential or otherwise) that specify actions to be taken by that system. Further, while only a single system is illustrated, the term “system” shall also be taken to include any collection of systems that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

In various embodiments, the processing system 500 includes one or more hardware processors 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The processing system 500 may further include a display unit 510 (such as a scanning projector system or other light engine) comprising a modulation controller 511, an alphanumeric input device 512 (e.g., a keyboard or other physical or touch-based actuators), and a user interface (UI) navigation device 514 (e.g., a pointing device, such as a touch-based interface). In one example, the display unit 510, input device 512, and UI navigation device 514 may comprise a touch screen display. The processing system 500 may additionally include a storage device (e.g., drive unit) 516, a signal generation device 518 (e.g., a speaker, such as audio output(s) 120 of FIGS. 1-4), a network interface device 520, and one or more sensors 521, such as a global positioning system (GPS) sensor, compass, accelerometer, or other sensor. The processing system 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a computer readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the processing system 500. In an example, one or any combination of the hardware processor 502, the main memory 504, the static memory 506, or the storage device 516 may constitute computer readable media.

While the computer readable medium 522 is illustrated as a single medium, the term “computer readable medium” may include a single medium or multiple media (e.g., a centralized or distributed database, and/or associated caches and servers) configured to store the one or more instructions 524.

The term “computer readable medium” may include any medium that is capable of storing, encoding, or carrying instructions for execution by the processing system 500 and that cause the processing system 500 to perform any one or more of the techniques of the present disclosure, or that is capable of storing, encoding or carrying data structures used by or associated with such instructions. Non-limiting computer readable medium examples may include solid-state memories, and optical and magnetic media. In an example, a massed computer readable medium comprises a computer readable medium with a plurality of particles having invariant (e.g., rest) mass. Accordingly, massed computer readable media are not transitory propagating signals. Specific examples of massed computer readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the processing system 500, and includes digital or analog communications signals or other intangible medium to facilitate communication of such software.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A wearable device, comprising:
a first frame that is wearable in proximity to an eye of a user, the first frame having a first electromechanical interface configured to facilitate connection to a corresponding second electromechanical interface of a selectably attachable second frame;
one or more lenses coupled to the first frame; and
one or more processors to control, via the connection to the corresponding second electromechanical interface, one or more operations of a light engine that is coupled to the selectably attachable second frame.

2. The wearable device of claim 1, wherein the one or more lenses coupled to the first frame are substantially transparent.

3. The wearable device of claim 2, wherein at least one of the one or more substantially transparent lenses is configured to provide a corrective optical power.

4. The wearable device of claim 1, further comprising one or more audio output devices carried by the first frame.

5. The wearable device of claim 1, further comprising one or more sensors carried by the first frame, the sensors comprising at least one of a group that includes a microphone, a camera, and an accelerometer.

6. The wearable device of claim 1, wherein the first electromechanical interface comprises a pogo pin interface.

7. The wearable device of claim 1, wherein one or more of the first frame and the second frame is coupled to power storage, and wherein the one or more processors control transfer of power from the power storage via the connection to the second electromechanical interface.

8. The wearable device of claim 1, wherein the one or more processors further control high-speed data transfer via the connection to the second electromechanical interface between one or more first components coupled to the first frame and one or more second components coupled to the second frame.

9. The wearable device of claim 1, wherein to control the one or more operations of the light engine includes to manage presentation of content by the light engine based at least in part on sensor information provided via the connection to the second electromechanical interface.

10. A display system, comprising:
a first frame structure coupled to a light engine, the light engine to generate a display light representative of content for presentation by the display system;
one or more optical elements configured to route the display light to an eye of a user; and
a first electromechanical interface that is coupled to the first frame structure and configured to facilitate connection from the light engine to a controller of the light engine via a corresponding second electromechanical interface of a selectably attachable second frame structure that comprises one or more lenses to be worn proximate to an eye of a user.

11. The display system of claim 10, wherein the one or more optical elements are configured to superimpose the display light over a view of an external environment via the one or more lenses of the selectably attachable second frame structure.

12. The display system of claim 10, comprising one or more sensors coupled to the first frame structure, the sensors configured to capture information from an external environment of the display system.

13. The display system of claim 12, wherein at least one of the one or more sensors coupled to the first frame structure comprises a camera configured to capture visual information from the external environment.

14. The display system of claim 12, wherein sensor data from the one or more sensors is routed to the controller of the light engine via the first electromechanical interface and the corresponding second electromechanical interface.

15. The display system of claim 10, wherein one or more of the first frame structure and the second frame structure is coupled to power storage, and wherein the connection to the second electromechanical interface provides transfer of power from the power storage.

16. A display system, comprising:
a first frame structure that is wearable in proximity to an eye of a user, the first frame structure comprising one or more lenses and a first electromechanical interface;
a second frame structure having a second electromechanical interface and coupled to a light engine and one or more optical elements, the light engine to generate a display light representative of content for presentation by the display system and the one or more optical elements to route the display light to the eye of the user; and
one or more processors to control the light engine via a selectably detachable connection between the first electromechanical interface and the second electromechanical interface.

17. The display system of claim 16, wherein one or more of the first frame structure and the second frame structure is coupled to power storage, and wherein the connection between the first electromechanical interface and the second electromechanical interface provides transfer of power from the power storage.

18. The display system of claim 16, wherein the connection between the first electromechanical interface and the second electromechanical interface provides both power transfer and communications between one or more first components coupled to the first frame structure and one or more second components coupled to the second frame structure.

19. The display system of claim 16, further comprising one or more sensors coupled to the second frame structure to generate sensor data, and wherein to control the light engine via the selectably detachable connection includes to control one or more operations of the light engine based at least in part on the sensor data.

20. The display system of claim 16, further comprising one or more audio outputs coupled to the first frame structure.
